(19) United States
(12) Patent Application Publication
(10) Pub. No.: US 2016/0066144 A1
(43) Pub. Date: Mar. 3, 2016

(54) Geolocation Service Discovery Tool

(71) Applicant: SOLOMO IDENTITY, LLC., Madison, WI (US)

(72) Inventors: Jennifer Weis, Hubertus, WI (US); Joe Barneson, Madison, WI (US)

(21) Appl. No.: 14/842,018

(22) Filed: Sep. 1, 2015

Related U.S. Application Data
(60) Provisional application No. 62/045,238, filed on Sep. 3, 2014.

(51) Int. Cl. H04W 4/02

(52) U.S. Cl. CPC H04W 4/021

(57) ABSTRACT

A geolocation discovery system provides an application executing on an individual's mobile wireless device that may detect the presence of hardware used to implement geolocation services or a location associated with known geolocation services. Upon such detection, the program consults with a location registry that identifies specific application programs or permissions necessary to use those geolocation services. The individual is then provided with information or access to the necessary programs or permissions.

### CROSS REFERENCE TO RELATED APPLICATION

This application claims the benefit of U.S. provisional application 62/045,238 filed Sep. 3, 2014 and hereby incorporated by reference.

### BACKGROUND OF THE INVENTION

The present invention relates to systems for providing location-aware services such as marketing, or the provision of location-specific information, and in particular to a system that helps individuals identify the availability of such location-aware services.

Geolocation systems allow location-aware interaction with a consumer or individual through his or her mobile device. Such geolocation systems may track the individual, for example, by monitoring the location of transmissions from the mobile devices, to selectively communicate with the individual on the basis of his or her tracked location. Alternatively, such geolocation systems may employ spatially limited wireless transmissions, These systems do not track an individual but are location-selective simply by the limitations of transmission power.

A common geolocation system with tracking can be implemented using the same wireless access points and routers used to establish a local area wireless network. Such wireless access points and routers communicate, for example, using the IEEE 802.11 Wi-Fi standard. Tracking is provided by measuring the signal strength, signal phase and/or reception angle of wireless data communicated between a mobile device and the wireless access points. Alternatively, the location of the mobile wireless device may be established by multilateration or multiangulation, or other interpolated techniques (henceforth, collectively, signal-based location). The location of the individual may then be used to selectively communicate with individuals based on their known locations.

Geolocation systems providing tracking may provide localized promotions to consumers in a retail environment but may also be used to locate critical personnel (such as medical personnel in a hospital or airline workers in an airport), to assist in navigation or to provide other similar services.

Geolocation systems without tracking may be implemented with multiple low-power transmitters such as those employing the Bluetooth low-energy standard. A number of low-powered and possibly battery-powered beacons with limited transmission power may be used to communicate selectively only with individuals within a limited area of the transmission.

Geolocation systems without tracking may be used to deliver location related information including promotional information to consumers in a retail environment or navigational or location specific general information, for example, to travelers in an airport or the like.

A common component of most geolocation systems is a geolocation application program running on the individual's portable wireless device, for example, running on a consumer's smart phone. Often such geolocation application programs are proprietary or unique to a single or limited number of venues. For example, a given store chain may have an application specific to that chain of stores only.

It is not uncommon for individual in a location with geolocation services to be unaware of the availability of the services, particularly if they do not have a proprietary geolocation application running on their portable wireless device.

### SUMMARY OF THE INVENTION

The present invention provides a system that helps an individual recognize the availability of geolocation services in his or her immediate environment and to quickly and easily obtain the necessary program or program authorizations needed to use those geolocation services. The system provides an application or other program executing on an individual's mobile wireless device that may detect the presence of hardware used to implement geolocation services or a location associated with known geolocation services. Upon such detection, the program consults with a location registry that identifies specific application programs or permissions necessary to use those geolocation services. The individual is then provided with information or access to the necessary programs or permissions.

### BRIEF DESCRIPTION OF THE FIGURES

FIG. 1 is a simplified plan view of multiple geolocation venues, for example, stores, each communicating with separate hardware for implementing geolocation services specific to that venue through specific application programs, and further showing an example mobile device that may identify the presence of geolocation services and find and execute the specific application programs needed for those geolocation services through the agency of a centralized location registry;

FIG. 2 is a simplified diagram of a database within the location registry linking venue locations to particular geolocation application programs;

FIG. 3 is a flowchart showing the steps of a program on the mobile device for interacting with the location registry according to the invention; and

FIG. 4 is an augmented version of the flowchart of FIG. 3 showing the provision of ancillary data to the venue owners contributing data to the location registry.

### DETAILED DESCRIPTION OF THE PREFERRED EMBODIMENT

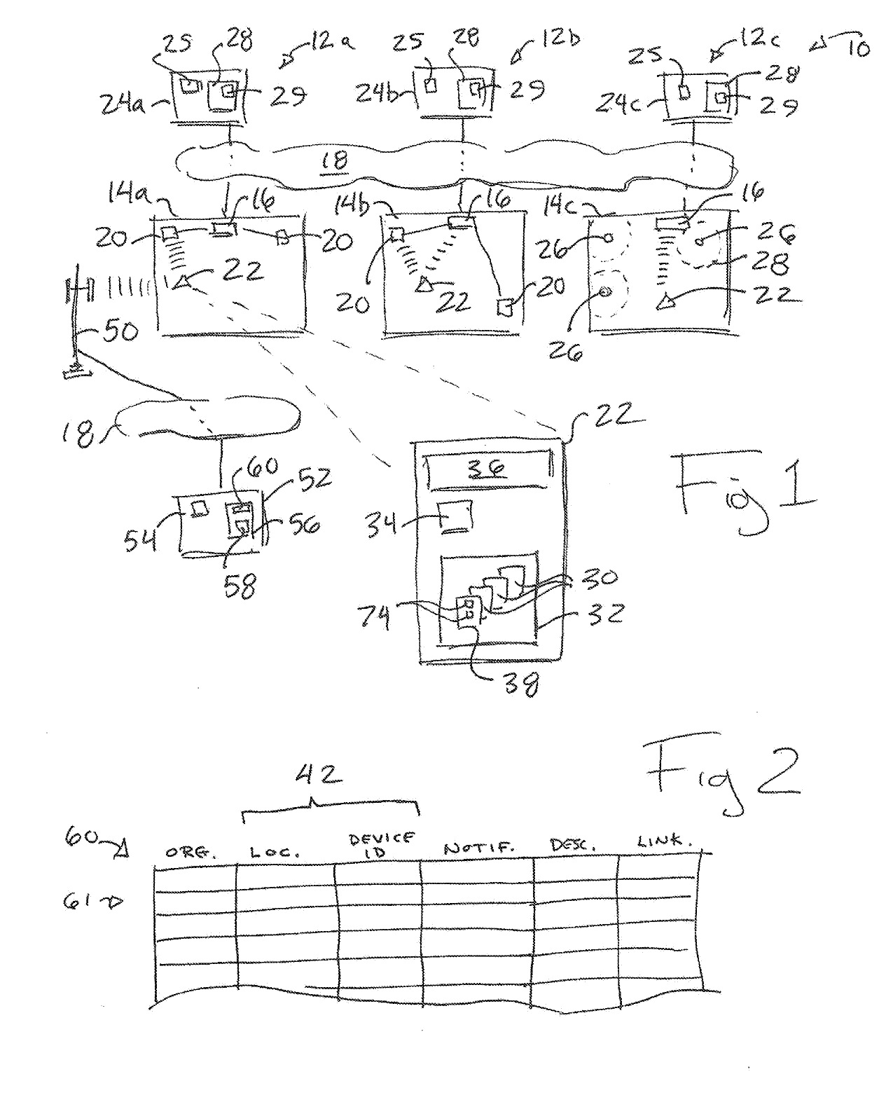

Referring now to FIG. 1, a geolocation environment 10 may include a set of geolocation systems 12a-12c each providing independent geolocation services, for example, to different venues 14a-14c. The venues 14 may be retail stores or businesses or public spaces such as museums, airports and hospitals.

The venues 14a and 14b, in this example, may each include a network portal 16, such as a router or the like providing for a computer with a processor executing a stored program held in a memory. Each network portal 16 may provide network interface capabilities, for example, between the Internet 18 and multiple wireless transceivers 20 distributed in the venue 14. These wireless transceivers 20 provide for communication with mobile wireless devices 22 (such as cell phones) held by individuals within the venues 14. The term mobile device is intended generally to cover all wireless devices such as tablets, cell phone, and the like communicating by radio waves, light, low-frequency magnetic field or other similar technology. In this regard, the term wireless is not limited to so-called WiFi communications but embraces any communication operating without the agency of wires.

The network portals 16 and/or the multiple wireless transceivers 20 may implement geolocation techniques to be able to determine the location of the mobile devices 22 through triangulation or the like. Geolocation systems suitable for use with the present invention are described in U.S. patent application Ser. No. 13/959,908 filed Aug. 6, 2013, and U.S. application Ser. No. 14/030,042 filed Sep. 18, 2013, both assigned to the assignee of the present application and hereby incorporated by reference in their entirety.

Referring still to FIG. 1, each of the network portals 16 may communicate via the Internet 18, or the like, with content servers 24a-24e. In this example, different content servers 24 may be associated with each different venue 14a-14c. The content servers 24 each include a processor 25 and a memory 27 holding one or more stored programs 29 and generally further communicate with user interface elements such as a terminal, keyboard, mouse, or the like as well as other computers. The content servers 24 may include in the programs 29 stored application programs 30 that may be downloaded to the mobile devices 22 in order that the users of the mobile devices 22 may receive the benefit of geolocation services in the associated venue 14.

The venue 14c in this example may provide a set of non-tracking beacons 26, for example, low-energy Bluetooth beacons, each transmitting in a limited area 28 to send information only to the mobile device 22 within the limited area 28 specific to the location of the mobile device 22 in the area 28.

In each of these venues 14, the user may interact with the multiple wireless transceivers 20 or the beacons 26 by means of one or more application programs 30 on the user's mobile device 22. As noted, these application programs 30 are often applicable to one or a few venues 14.

Referring still to FIG. 1 and the expanded block diagram of the mobile device 22, the application programs 30 may reside in an electronic memory 32 of the mobile device 22, the latter communicating with a processor 34 which in turn communicates with mobile device hardware 36 including but not limited to a cellular communication transceiver, a GPS transceiver, a Wi-Fi transceiver, a Bluetooth transceiver or wireless near field communication devices. The mobile device hardware 36 may also include standard interface circuitry such as, for example, a touchscreen, a keyboard, and an audio transducer or the like, as well as components of a smart phone including, for example, accelerometers, magnetometers, microphones, biometric sensors, and the like.

In one embodiment of the present mention, a finder program 38 may be included in the memory 32 of the mobile device 22, the finder program 38 providing a tool helping the owner of the mobile device 22 detect that he or she is in a region where geolocation services are provided. It will be appreciated that this finder program 38 may be alternatively incorporated into the firmware of the mobile device 22. Generally, the finder program 38 desirably operates continuously in the background of the wireless device with the user's permission so as to notify the user of the mobile device 22 of the availability of geolocation services without further action on his or her part.

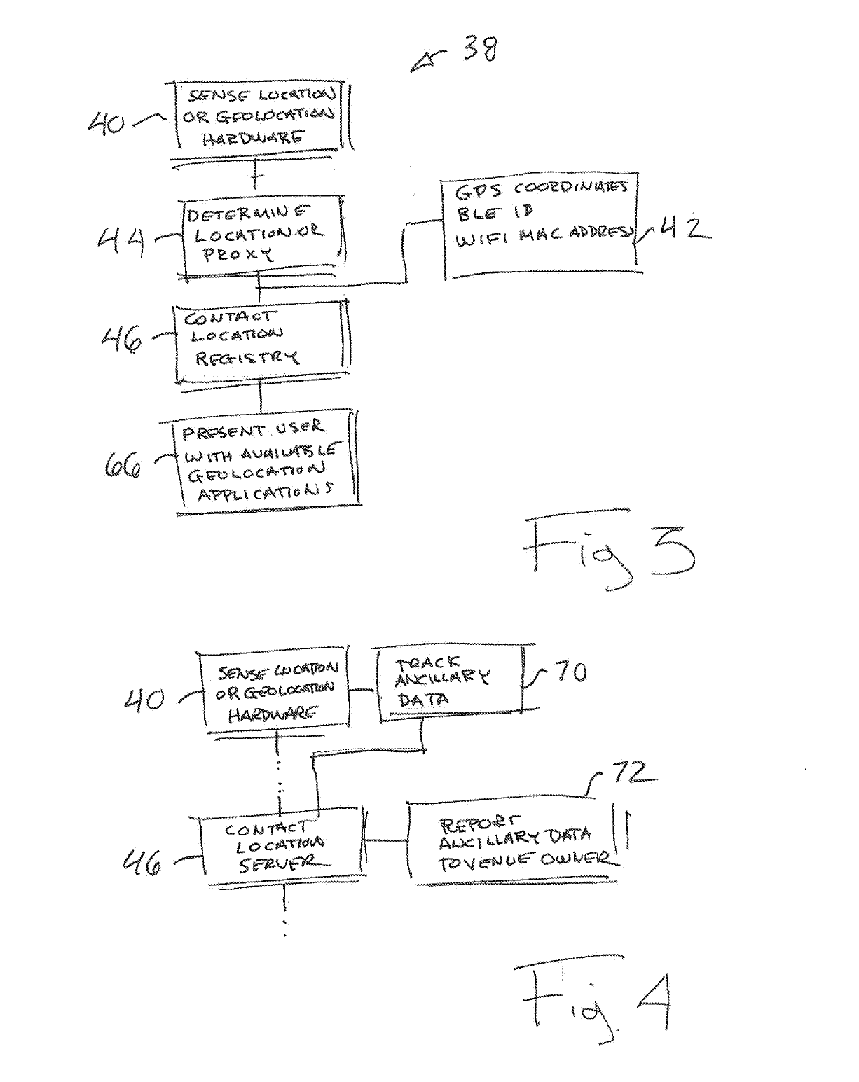

Referring now also to FIG. 3, finder program 38 may continuously monitor wireless signals received, as indicated by process block 40, to detect geolocation hardware. In this way the finder program 38 may detect, for example, the normal protocol signals from local wireless transceivers 20 or from Bluetooth enabled beacons 26. It is contemplated that this detection process will look at generic qualities of the transmissions of such local wireless transceivers 20 or beacons 26 and need not be able to specifically identify systems used for geolocation services, although it is contemplated that the invention may work with future geolocation systems that transmit signals, specifically indicating their purpose for geolocation services.

If at process block 40 such hardware is detected, or alternatively periodically if GPS deduced coordinates are relied upon, the finder program 38 extracts location information 42 that may be used to determine the current location as indicated by process block 44. For current technology, the location information 42 may be a unique MAC (media access control) address for Wi-Fi signals transmitted from local wireless transceivers 20 and/or a unique identification transmitted by Bluetooth enabled beacons 26. This information does not directly indicate a location that serves as a proxy for a location based on the known location of the wireless transceivers 20 or beacons 26. As noted above, the location information 42 may also be actual spatial coordinates obtained from a GPS transceiver or cellular tower triangulation techniques known in the art.

This location information 42 identified at process block 44 is then used at process block 46 to contact a location registry server 52. As shown in FIG. 1, this contacting may be via cellular signals communicating from the mobile device 22 to a cellular tower 53 and then to Internet 18 to the location registry server 52, or by a local Wi-Fi communication through the network portals 16 of the particular venues 14 or other mechanisms to the Internet 18 to the location registry server 52.

Referring now to also FIG. 2, the location registry server 52 may provide for a processor 54 and electronic memory system 56 including, for example, solid-state and disk drive systems. Electronic memory system 56 may hold a database program 58 implementing the location registry and an application program server 60 for serving application programs 30 or finder programs 38 to cellular devices 22. Alternatively the serving process of the application program server 60 may be undertaken by a separate application device, for example, associated with the particular brand of mobile device 22.

The mobile device 22 communicates the location information 42 to the location registry server 52 which is applied to a database program 58 of the location registry server 52. The database program 58 links a number of types of information together in a record in a database table 61 including the name of the organization providing the geolocation services and location information 42 including the location of the venue (used for matching of GPS coordinates to a particular record when GPS is available) and a device ID (indicating the device and ID number for matching device IDs to particular records when these IDS are available). Each record may also provide for a preferred type of notification to the user that geolocation services are available (e.g. push notification), a short description of the geolocation services that can be provided to the user, and a link 64 to any necessary application program for using the geolocation services. This geolocation information 64 may, for example, provide a text description of the geolocation service and the benefits to the user of the mobile device 22 and the necessary information or data (for example, a link to an application program 30) necessary to use the geolocation services identified by the geolocation information 64.

The location registry server 52 may then reply to the mobile device 22, as indicated by process block 66, with the geolocation information 64 (typically including link information) allowing the user of the mobile device 22 to download the application program 30 to the mobile device 22 and thus be able to make use of the immediate geolocation services. The invention is not limited to providing users with links to application programs 30 for the download of the application programs that may more generally provide for any type of communication with respect to geolocation services including text or the connection to a website associated with geolocation service. More generally, the user may be alerted simply to a geolocation service.

It will be appreciated that the downloading process for any application program 30 may be preapproved by the user of the mobile device 22 and performed automatically in a manner invisible to that user or may include multiple steps of authorization and permission. Alternatively, the experience by the user of the mobile device 22 may simply be to receive a push notification (for example, a text crawler or audio signal) letting them know, at any time, that they have entered into a region where geolocation services are available. The user may then respond to the push notification and may provide for additional instructions to the finder program 38 to obtain the opportunity to download or activate the necessary application program 30 for using the services.

In one embodiment, the finder program 38 may receive and store a set of user preferences so that only geolocation services in particular categories of interest to the user result in a push notification and others require active requests by the user for information about local geolocation services before they are identified. It will be understood that these preferences may be subject to privacy constraints and, if authorized by the user, may be information that may be collected and provided to the venue holders.

Rather than the downloading of a separate application programs 30, it is also contemplated that the finder program 38 may incorporate or serve as a conduit for the functionality of all the necessary application programs 30 and thus may provide the functionality of any needed application program 30 for the implementation of desired geolocation service, by simply setting permission flags 71 which implement those features. In this way the finder program 38 may enforce a set of privacy rules for the consumer, for example, as described in U.S. patent application Ser. No. 13/683,041 filed Nov. 21, 2012, and U.S. application Ser. No. 13/683,566 filed Nov. 21, 2012, both assigned to the assignee of the present application and hereby incorporated by reference. Centralizing the geolocation services through the finder program 38 may also permit the sharing of other information between the user of the mobile device 22 and the owners of the venues 14 with revokability also described in the above-referenced patent applications.

Referring now to FIG. 4, the location registry server 52 may also work in conjunction with the finder program 38 to augment the application programs 30 with ancillary data as indicated by process block 70. This ancillary data, for example, may be provided to the venue holders to encourage their participation in the location registry system. Such ancillary data may include longitudinal statistics about the wireless device 22 as it crosses various venues 14 not normally available to the application programs 30 which are venue specific. Alternatively the ancillary data may provide for improved or more detailed statistics, such as heat maps or dwell times indicating how a consumer moves through a retail environment, that may not be provided by the individual application programs 30 but desired by their owners. Such information is described in the above-referenced patent applications.

One particular type of ancillary data that may be provided by the finder program 38 working with the location registry server 52 is an identification of low battery signals transmitted by beacons 26. Such signals indicate that the batteries providing power to the beacons 26 are running low. Generally the beacons 26 will not have a direct path of communication to the venue holder; however, the finder application may enlist multiple wireless devices 22 for the purpose of reporting back to the venue holders the battery status. At the time when hardware is sensed at process block 40, this information may be collected at process block 70, and through the contact with the location registry of process block 46, reported to the venue holder at process block 72 along with other ancillary data. In this way, the finder program 38 may provide a service to the venue holders that enlists far more mobile devices 22 holding the finder program 38 than would be the case if such a connection were provided by mobile devices having specific application programs 30 related to a particular venue.

It will be appreciated that the finder program 38 may operate as a privacy portal controlling privacy settings for the individual users of the mobile devices 22 as described in the above referenced co-pending application. In addition, the present invention may work with the global geolocation search service described in U.S. provisional patent application 61/938,396 filed Feb. 11, 2014, also hereby fully incorporated by reference.

The term venue owner as used herein is not intended to be limited to owners of the physical venue but rather any individual or organization having proprietary rights in the information that can be obtained from geolocation in the venue.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” arc intended to be inclusive and mean that there may be additional elements or features other than those specifically noted, It is further to be understood that the method steps, processes, and operations described herein are not to be construed as necessarily requiring their performance in the particular order discussed or illustrated, unless specifically identified as an order of performance. It is also to be understood that additional or alternative steps may be employed.

References to “a microprocessor” and “a processor” or “the microprocessor” and “the processor,” can be understood depending on context to include one or more microprocessors that can communicate in a stand-alone and/or a distributed environment(s), and can thus be configured to communicate via wired or wireless communications with other processors, where such one or more processor can be configured to operate on one or more processor-controlled devices that can be similar or different devices. Furthermore, references to memory, unless otherwise specified, can include one or more processor-readable and accessible memory elements and/or components that can be internal to the processor-controlled device, external to the processor-controlled device, and can be accessed via a wired or wireless network.

It is specifically intended that the present invention not be limited to the embodiments and illustrations contained herein and the claims should he understood to include modified forms of those embodiments including portions of the embodiments and combinations of elements of different embodiments as come within the scope of the following claims. All of the publications described herein, including patents and non-patent publications, are hereby incorporated herein by reference in their entireties.

What is claimed is:

1. A geolocation discovery system comprising:
(1) at least one portable wireless device including an electronic computer executing a stored program to:
(a) detect the presence of hardware used to implement geolocation services or a location associated with known geolocation services by means of radio transmissions from that hardware;
(b) query a location registry that identifies specific application programs or permissions necessary to use those geolocation services;
(c) receive from the location registry information permitting of the geolocation services;
(2) a location registry providing wireless communication with the at least one portable wireless device to receive queries from the at least one portable wireless device to provide information permitting the use of geolocation services proximate to the at least one portable wireless device.
